(19) United States
(12) Patent Application Publication
(10) Pub. No.: US 2012/0176789 A1
(43) Pub. Date: Jul. 12, 2012

(54) LIGHT OUTPUT STICKER

(75) Inventors: Maarten Marinus Jhannes Wilhelm Van Herpen, Eindhoven (NL); Arnoldus Johannes Lucas Maria Maandonks, Eindhoven (NL); Tim Dekker, Eindhoven (NL)

(73) Assignee: KONINKLIJKE PHILIPS ELECTRONICS N.V., EINDHOVEN (NL)

(21) Appl. No.: 13/392,884

(22) PCT Filed: Sep. 27, 2010
(86) PCT No.: PCT/IB2010/054333

§ 371 Date: Feb. 28, 2012

(30) Foreign Application Priority Data
Sep. 30, 2009 (EP) 09171735.5

(51) Int. Cl. F21V 33/00

(52) U.S. Cl. 362/234

(57) ABSTRACT

A light output sticker (10) comprises a flexible transparent substrate arrangement (11). A plurality of light source devices (14) are provided on or in the flexible substrate arrangement (11). A conductor arrangement (12) comprises conductor lines which connect to the light source devices. An adhesive layer (15) and release liner (16) are provided for attaching the sticker to an external substrate. The applied sticker is substantially transparent. The sticker of the invention avoids the need to embed the LEDs in a glass structure during the manufacturing of the glass. Instead, the LEDs are part of the transparent sticker, which can be added to a glass (or other material) substrate after manufacture of both the sticker and the glass (or other) material to which it is to be attached.

### FIELD OF THE INVENTION

This invention relates to a light output sticker, in particular using discrete light source devices provided on an adhesive backing for application to a product. The invention also relates to a lighting system using the sticker and an installation method.

### BACKGROUND OF THE INVENTION

An adhesive LED ribbon is a known device for providing lighting effects to a surface. Such devices comprise a strip of material on which LEDs are mounted, with electrical connections running along the strip of material. A problem with such devices is that they detract from the appearance of the surface when they are turned off.

Another known device is a so-called “LED in glass” device. An example is shown in FIG. 1. Typically a glass plate is used, with a transparent conductive coating (for example ITO) forming electrodes. The conductive coating is patterned in order to make the electrodes, that are connected to a semiconductor LED device. The assembly is completed by laminating the glass, with the LEDs inside a thermoplastic layer (for example polyvinyl butyral, PVB).

Applications of this type of device are shelves, showcases, facades, office partitions, wall cladding, and decorative lighting. The lighting device can be used for illumination of other objects, for display of an image, or simply for decorative purposes.

These devices enable transparency to be achieved when turned off, so that the visual appearance is improved, and they provide a fully integrated product. There are however several problems with current LED in glass products:

(i) The layout of the LEDs cannot be customized by the user, because otherwise the production of the LED in glass product becomes very expensive.

(ii) Power connections need to be made to the transparent conductive coating. This means that the glass plate cannot be cut to a desired length without first providing power connections.

(iii) Because the LEDs need to be placed during the production of the glass, the glass factory needs to be modified, which strongly increases the cost of the LED in glass product.

(iv) If an LED fails, the entire glass structure needs to be replaced.

### SUMMARY OF THE INVENTION

According to the invention, there is provided a light output sticker comprising:

a flexible transparent substrate arrangement;

a plurality of light source devices provided on or in the flexible substrate arrangement;

a conductor arrangement comprising conductor lines which connect to the light source devices;

an adhesive layer for attaching (e.g. bonding), the sticker to an external substrate; and

a removable release liner over the adhesive layer,

wherein the sticker, excluding the release liner, is at least 70% transparent.

The sticker of the invention does not embed the LEDs in a glass structure during manufacture. Instead, the LEDs are part of the transparent sticker, which can be added to a glass (or other material) substrate subsequently. For example, the sticker can be applied to glass windows or partitions after they have been installed in a building. The sticker of the invention can also easily be removed. The applied sticker is transparent (i.e. at least 70% transparent, but preferably at least 90%, more preferably even 95% transparent), so that when turned off, it does not noticeably detract from the appearance of the substrate to which it is applied. The configuration of the light source devices can be selected according to the desired end use, without giving rise to significant increased manufacturing costs. In particular, the cost of manufacture of the sticker is relatively low, so that the light source device layout can be tailored more efficiently to specific applications and desired visual appearance and lighting effects.

The “external substrate” is a base to which the sticker is applied. It may be flat or non-flat. By “external” is meant that it does not form part of the structure of the light output sticker, in that it can be manufactured separately and without needing any special modification to enable the sticker of the invention to be used in combination with it.

The sticker can be in the form of a continuous sheet (with a continuous surface) so that it can be applied in the manner of a transfer. The continuity of the sheet maintains the desired spatial locations of the light source devices.

It is known to use stickers on glass in order to create an etched glass appearance. For example, etched vinyl decals may be used, such as a self-adhesive frosted film that is easily removed and replaced to update the appearance at a later time. Etched vinyl decals have a permanent acrylic adhesive system protected by a removable release liner which must be removed prior to installation. The same known technology of self-adhesive films for application to glass can be used by the sticker of the invention.

The conductor arrangement can comprise a patterned, at least semi-transparent, conductive layer. Thus, the sticker can have a laminate structure of stacked layers.

The conductor lines can connect to the light source devices with conductive glue or solder portions. The light source devices can thus be discrete packaged components.

The adhesive layer can comprise a transparent self-adhesive layer.

In one example, the adhesive layer is on one side of the substrate and the light source devices are on the opposite side of the substrate.

In another arrangement, the adhesive layer is on one side of the substrate and the light source devices are on top of the adhesive layer. In this case, the mounted sticker provides protection for the light source devices.

In another arrangement, the adhesive layer can be on one side of the substrate, and the light source devices (and optionally also the conductor arrangement) embedded within the substrate. This provides an arrangement with the light source devices integrated into a laminated package.

In another arrangement, the conductor arrangement can be on one side of the substrate, the adhesive layer provided over the conductor arrangement, and the light source devices again embedded within the substrate. The adhesive layer can then comprise openings at the locations of the light source devices. These assist cooling of the light source devices.

The light source devices can each comprise an LED device or a group of LED devices, for example inorganic LEDs, organic LEDs, polymer LEDs or laser diodes.

In one embodiment the surface of the sticker is made to create an etched glass appearance. The advantage of this embodiment is that the presence of LED chips is masked by the etched glass effect.

The light source devices can provide an output for directional guiding, for example for emergency guiding.

The invention also provides a lighting system comprising the sticker of the invention and a glass panel to which the sticker is applied, thereby forming a light emitting glass panel.

The invention also provides a method of installing a light output sticker, comprising:

providing a sticker of the invention;

removing the release liner, and applying the adhesive layer to the external substrate; and

applying pressure to the sticker in order to remove air from between the sticker and the external substrate.

The external substrate is preferably transparent, and can comprise a window of a building. However, the external substrate may also be non-transparent such as for example wood or stone, in which case the light output sticker of the present invention may be added to this surface without significantly changing the appearance.

### BRIEF DESCRIPTION OF THE DRAWINGS

Examples of the invention will now be described in detail with reference to the accompanying drawings, in which:

FIG. 1 shows a known LED in glass illumination device;

FIG. 2 shows a single LED of the device of FIG. 1 in more detail;

FIG. 3 shows of a first embodiment of lighting sticker having an adhesive layer on the opposite side to the LEDs;

FIG. 4 shows a second embodiment of lighting sticker having an adhesive layer on the same side as the LEDs.

FIG. 5 shows the second embodiment after it has been applied to a glass sheet;

FIG. 6 shows a third embodiment of lighting sticker with LEDs embedded in the foil; and

FIG. 7 shows a fourth embodiment with holes in the adhesive layer.

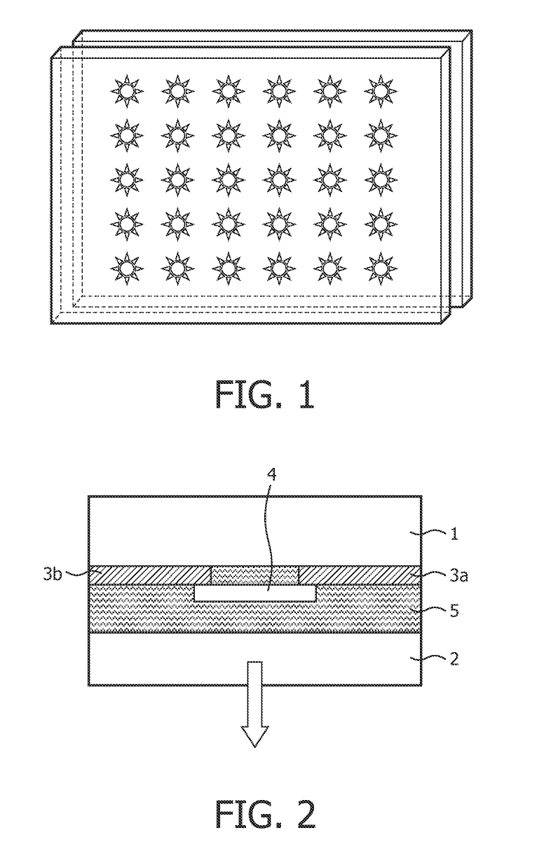

The same reference numbers are used to denote similar parts in the different figures showing the different embodiments of sticker of the invention.

### DETAILED DESCRIPTION

The invention combines the structure of an LED-in-glass structure with a sticker approach, so that the cost of manufacture of an LED-in-glass approach is avoided, but the benefits of high transparency can be achieved.

The structure of a known LED in glass illumination device is shown in FIG. 2. The lighting device comprises glass plates 1 and 2. Between the glass plates are (semi-) transparent electrodes 3a and 3b (for example formed using ITO), and a LED 4 connected to the transparent electrodes 3a and 3b. A layer of thermoplastic material 5 is provided between glass plates 1 and 2 (for example PVB or UV resin).

The glass plates typically may have a thickness of 1.1 mm-2.1 mm. The spacing between the electrodes connecting to the LED is typically 0.01-3 mm, for example around 0.15 mm. The thermoplastic layer has a typical thickness of 0.3 mm-2 mm, and the electrical resistance of the electrodes is in the range 2-80 Ohm, or 10-30 Ohms/square.

The electrodes are preferably at least semi-transparent, so that they are imperceptible to a viewer in normal use of the device. If the conductor arrangement does not introduce a variation in light transmission (for example because it is not patterned, or because the pattern cannot be seen), a transparency of the conductors themselves of greater than or equal to 50% may be sufficient for the overall system to be transparent. More preferably, the transparency is greater than 70%, more preferably 90%, and even more preferably 99%. If the conductor arrangement is patterned (for example because thin wires are used), the transparency of the conductors is preferably greater than 80%, more preferably 90%, but even more preferably greater than 99%.

The electrodes can be made of a transparent material such as ITO or they can be made of an opaque material such as copper but be sufficiently thin so that they are not visible in normal use. Examples of suitable materials are disclosed in U.S. Pat. No. 5,218,351.

The current invention provides an alternative solution for providing a film light source device on a transparent substrate, such as a glass substrate. LEDs are mounted on a transparent sticker, which can be added to a glass (or other material) substrate by an installer, rather than as part of a manufacturing process.

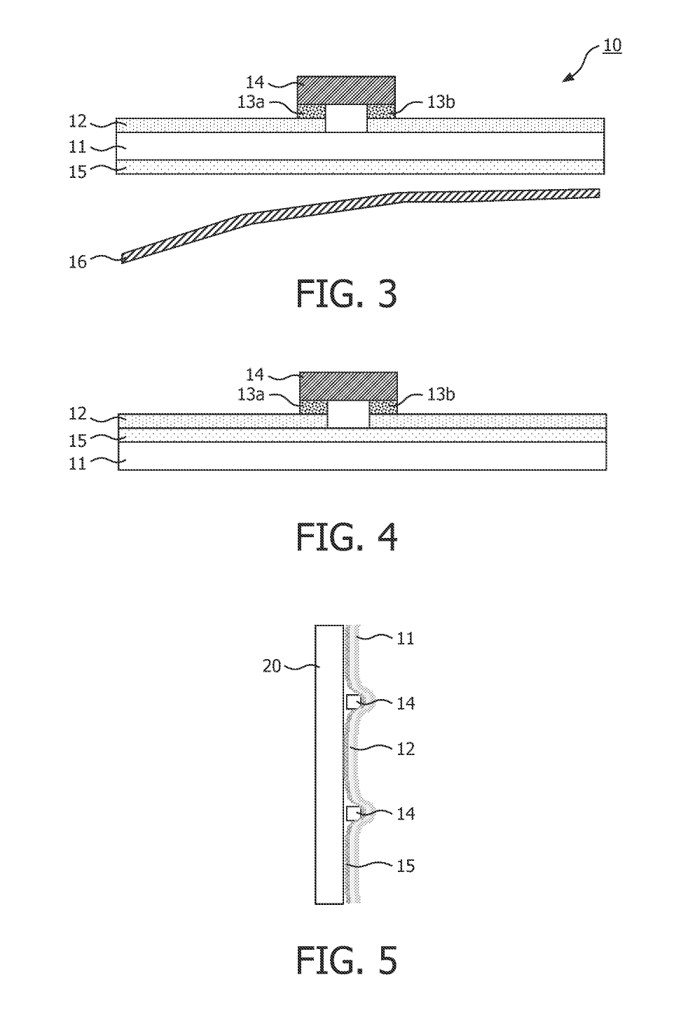

A first embodiment of sticker 10 according to the present invention is shown in FIG. 3.

The first embodiment of sticker 10 comprises a flexible transparent strip 11 in the form of a foil, for example a plastic (PE, PP, PVC, PMMA) or rubber. The thickness is less than 3 mm, but preferably less than 1 mm, or even less than 0.5 mm. The area depends on the surface to which it will be applied, with dimensions ranging from a few cm2, to more than 1 m2, or even 10 m2. An at least semi-transparent conductive layer 12 is provided, onto which LEDs 14 are mounted (for example with connections 13a and 13b which may comprise a conductive glue or solder). Furthermore, the transparent strip 11 also comprises a transparent self-adhesive layer 15, which may be used to adhere the strip to for example a sheet of glass.

The self-adhesive layer can be any known self-adhesive layer, for example as used for the etch glass stickers.

A removable release liner 16 is provided, which is removed in order to expose the self-adhesive layer 15.

The layer 12 is at least semi-transparent. As for the known design, a transparency of greater than or equal to 70% is sufficient for the system to appear transparent. More preferably, the transparency is greater 90%, and even more preferably 99%. This transparency can be achieved using for example a patterned transparent conductive oxide, but it may also be realized using thin conductive wires (the first has the advantage of better uniformity in transparency, the latter has the advantage of better electrical conductivity).

In FIG. 3, the adhesive layer 15 is opposite from the location of the LEDs. However, in a second embodiment shown in FIGS. 4 and 5, the adhesive layer 15 is on the same side as the LEDs. The advantage of this embodiment is that after adhering the strip to for example a glass window, the LED is protected between this glass and the foil 11. It is noted that the conductor lines defined by layer 12 are narrow lines, so that nearly all of the adhesive layer is exposed to the upper surface of the sticker (this cannot be seen from FIG. 4).

FIG. 4 shows the structure and FIG. 5 shows the arrangement adhered to a glass panel 20.

Alternatively, the adhesive layer can be provided on top of the conductor arrangement, especially when a transparent conductive material such as ITO is used. In that case the sticker comprises for example a transparent substrate 11 with a patterned ITO layer 12 that is provided with LEDs 14, and the ITO layer+LEDs is coated with an adhesive layer 15 onto which a release liner 16 may be applied. Thus, the adhesive layer is over the electrodes 12 and LEDs instead of underneath as in FIG. 4.

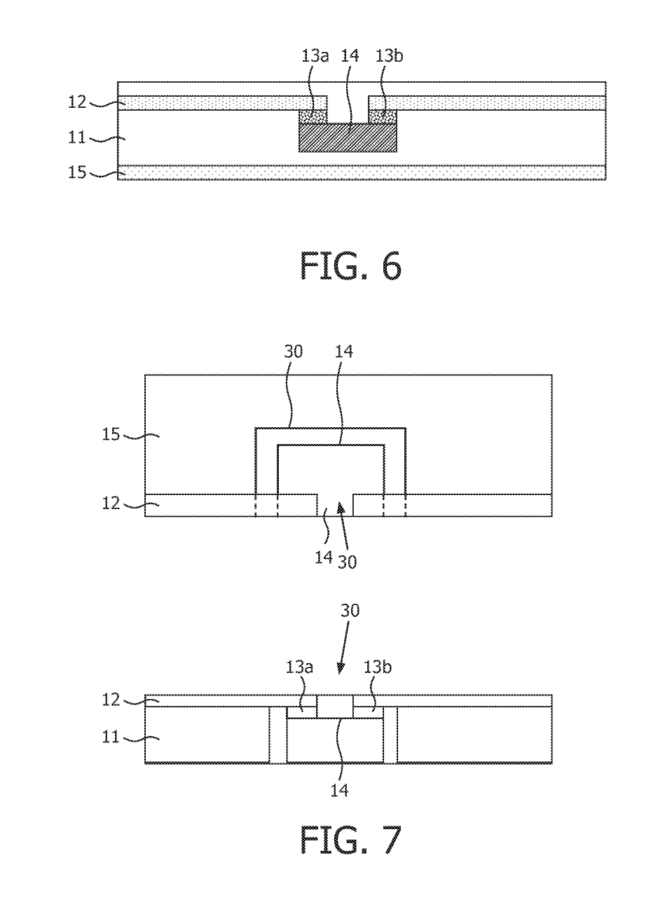

In a third embodiment shown in FIG. 6, the LEDs are embedded in the foil 11. The LEDs 14 and the conductor arrangement (12 and 13a,13b) are both also embedded inside the foil 11.

In a fourth embodiment shown in FIG. 7 (in plan view above and in end view below), the sticker 15 has holes 30 near the location of the LEDs 14. The advantage of this embodiment is that air may pass through these holes. A second advantage is that the surface may be more flat compared to the embodiment of for example FIG. 5. A third advantage is that it may be easier to manufacture.

In a variation to this embodiment, the holes may not extend entirely through the sticker. Instead, the top and/or bottom layer may be closed. The advantage is that the LED is now protected against wear inside the sticker, and the surface is flat. The disadvantage is that air cannot pass through the holes when applying the sticker. For example, there may be holes only on the side of the sticker with the adhesive layer, such that the LED is protected between a closed layer on one side and the release liner on the other side (or for example a glass plate instead of release liner when the sticker is applied).

In all examples above, the LED 4 may emit light away from the foil 11, or towards the foil 11, or both, depending on the type of application and the location of the adhesive layer.

In order to supply the LEDs with electrical power, a power connection needs to be made. For example, a copper foil can be conductively attached on both sides of the foil 11, such that an electrical connection with a power supply may be made.

Alternatively, a dedicated connector can be used to make the power connection. The connector may for example comprise pins that penetrate into the conductive layer 12 in order to make contact.

The invention also provides a method of installation, which comprises the steps of:

(i) Installing a glass window;

(ii) Cleaning the glass window;

(iii) Removing a release liner from the LED foil;

(iv) Applying the LED foil to the window; and

(v) Applying pressure to the LED foil in order to remove air from between the glass and the LED sticker.

Steps (i) and (ii) are preparatory steps, and the invention relates specifically to steps (iii) to (v). The invention applies to other substrates, not only glass windows.

The LEDs can simply be controlled to be turned on or off, either all together, or in sub-groups. However, a control system can be provided for controlling the LEDs on the foil. The control system can implement dimming of the LEDs, for example using a pulse-width modulation method. However, more advanced controls are possible, for example individually controlling each LED on the foil, using for example a passive matrix or active matrix driving method. The control system can control the color of the LEDs, by providing the LEDs as groups of RGB LEDs.

The invention can be applied to windows for indoor lighting, but also for outdoor lighting. For example, the light emitting windows may be used to illuminate the facade of a building.

In another application, the LEDs can be used to illuminate a glass wall, for example used as office wall or office partition wall.

Other applications may be for example in glass tables or desks, glass or plastic shelves (for example in retail outlets) or for example for illuminating the steps of stairs.

The LED and conductor arrangement can be coated with a water-proof coating. For example, parylene or rubber may be used for this.

In the examples above, the LEDs emit light in a direction normal to the plane of the sticker. In another embodiment, the LEDs can be arranged to emit light sideways into the transparent foil. In that case the LED is still embedded in the sticker, but there has to be an air gap between the emission surface of the LED and the foil 11, in order for the light to be captured inside the foil. Light can then subsequently be coupled out of the foil using out-coupling structures such as for example painted dots, or scratched areas.

As alternative to solid state LEDs, other light source devices may be used, such as OLED, polymer LED, or laser sources. The advantage of solid state LEDs is that they are small, robust, highly efficient and low-cost. The advantage of alternative light source devices may be that they are surface emitters or that they are flexible (like OLEDs).

The examples above have shown a small array of light source devices. However, it will be understood that the invention is typically implemented as many LED devices, provided on a large substrate. A typical distance between the LEDs may be 1 cm to 10 cm, for example approximately 3 cm.

Each light source device may also comprise a single LED or multiple LEDs.

In one aspect, the invention provides a lighting system comprising the sticker, a power supply and a controller arranged to control the lighting devices on the sticker. The controller may be arranged external from the sticker but may also be integrated in the sticker. The controller controls the one or more light sources devices. Optionally, the system may further comprise a sensor. The controller may then be arranged to control the light output of the sticker in response to a sensor signal of the sensor. The term “sensor” may also relate to a plurality of sensors. Such plurality of sensors may for instance be arranged to sense the same parameter (like touch of a user) at different locations, or to sense different parameters (like touch of a user and smoke, respectively).

The sticker may be used to show decorative patterns, but may also be used to provide information, such as by providing a light pattern containing information like arrows, commercial information, etc.

In a further embodiment the sticker is used to make an emergency escape route lighting system that may be activated in case of an emergency. The sticker can be located on the wall, floor or ceiling. The sticker arrangement may comprise a plurality of light source devices, which may optionally be connected with each other. The sticker may for example be arranged to generate light in the shape of light spots, but may also be in the shape of arrows, to point into the right direction for escape. This arrow may also be made variable, such that the direction of the arrow may be changed depending on the location of the emergency. For example, the arrow may point away from a fire hazard. Instead of an arrow, blinking lights may be used to point into a direction. In the same way, arrows can be used to provide other information such as arrows indicating commercial information at a particular location. One or more of color, pattern shape, on/off state, output intensity, and information content of the light output devices may be variable and may be controlled by the controller.

Furthermore, one or more of color, pattern, shape and information content of the light may be dependent on a sensor signal of a sensor (such as a touch or approach sensor or fire sensor or smoke sensor or thermal sensor, etc.), wherein the sensor is arranged to sense an object on or in the vicinity of the sticker or is arranged to sense a feature selected from the group consisting of smoke and heat, and wherein the controller is arranged to control one or more of color, on/off state, intensity, pattern shape and information content of the light in dependence of the sensor signal.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage. Any reference signs in the claims should not be construed as limiting the scope.

1. A light output sticker comprising:
a flexible transparent substrate arrangement;
a plurality of light source devices provided on or in the flexible substrate arrangement;
a conductor arrangement comprising conductor lines which connect to the light source devices;
an adhesive layer for attaching the sticker to an external substrate; and
a removable release liner over the adhesive layer,
wherein the sticker, excluding the release liner, is at least 70% transparent.

2. A sticker as claimed in claim 1, wherein the flexible transparent substrate arrangement defines a continuous surface of a desired outer size and shape.

3. A sticker as claimed in claim 1, wherein the conductor arrangement comprises a patterned at least semi-transparent conductive layer.

4. A sticker as claimed in claim 1, wherein the adhesive layer comprises a transparent self-adhesive layer.

5. A sticker as claimed in claim 1, wherein the adhesive layer is on one side of the substrate and the light source devices are on the opposite side of the substrate.

6. A sticker as claimed in claim 1, wherein the adhesive layer is on one side of the substrate and the light source devices are on top of or embedded within or coated with the adhesive layer.

7. A sticker as claimed in claim 1, wherein the adhesive layer is on one side of the substrate and the light source devices are embedded within the substrate.

8. A sticker as claimed in claim 7, wherein the adhesive layer is provided over the conductor arrangement on the one side of the substrate.

9. A sticker as claimed in claim 8, wherein the adhesive layer defines a plurality of openings at the locations of the light source device.

10. A sticker as claimed in claim 1, wherein the light source devices each comprise an LED device or a group of LED devices.

11. A sticker as claimed in claim 10, wherein each light source device comprises an inorganic LED, an organic LED, a polymer LED or a laser diode.

12. A sticker as claimed in claim 1, wherein the light source devices provide an output for directional guiding.

13. A lighting system comprising a sticker as claimed in claim 1 and a lighting controller for controlling the light source devices.

14-15. (canceled)
